(19) United States
(12) Patent Application Publication
(10) Pub. No.: US 2020/0358706 A1
(43) Pub. Date: Nov. 12, 2020

(54) COMPUTER-READABLE RECORDING MEDIUM RECORDING PACKET CLASSIFICATION PROGRAM, PACKET CLASSIFICATION METHOD, AND INFORMATION PROCESSING APPARATUS

(71) Applicant: FUJITSU LIMITED, Kawasaki-shi (JP)

(72) Inventor: Katsuhiko Ookubo, Kawasaki (JP)

(73) Assignee: FUJITSU LIMITED, Kawasaki-shi (JP)

(21) Appl. No.: 16/850,057

(22) Filed: Apr. 16, 2020

(30) Foreign Application Priority Data
May 8, 2019 (JP) 2019-088452

(51) Int. Cl. H04L 12/851

(52) U.S. Cl. CPC H04L 47/2441

(57) ABSTRACT

A recording medium recording a packet classification program for causing a computer to perform processing includes: storing, by every one of a plurality of threads, in a case where input packets include identification information of terminals identification information of sessions used for transmitting the input packets, in association with classification categories associated with the terminals and time information in the input packets; specifying, by every one of a plurality of classification threads that performs classification processing of the input packets, in a case where a target packet of the classification processing does not include identification information of a terminal that processes the target packet, classification categories associated with identification information of a session used for transmitting the target packet and a time equal to or earlier than time Information in the target packet; and classifying the target packet into a classification category associated with a relatively later time.

### CROSS-REFERENCE TO RELATED APPLICATION

This application is based upon and claims the benefit of priority of the prior Japanese Patent Application No. 2019-88452, filed on May 8, 2019, the entire contents of which are incorporated herein by reference.

### FIELD

The embodiments discussed herein relate to a packet classification program, a packet classification method, and an information processing apparatus.

### BACKGROUND

Mobile telecommunication technologies such as Long Term Evolution (LTE) standardized by 3rd Generation Partnership Project (3GPP) have become widespread. FIG. 1 illustrates an example of an LTE network. Terminals 7 (7a and 7b) connect to an evolved Node B (eNB) 1 and perform communication. The eNB 1 is connected to a mobility management entity (MME) 2 and a serving gateway (SGW) 4. The MME 2 is connected to a home subscriber server (HSS) 3 and the SGW 4. The SGW 4 is connected to Internet 6 via a packet data network gateway (PGW) 5.

Japanese Laid-open Patent Publication No. 2015-204538 and Japanese Laid-open Patent Publication No. 2018-137499 are disclosed as related art.

### SUMMARY

According to an aspect of the embodiments, a non-transitory computer-readable recording medium having stored therein a packet classification program for causing an information processing apparatus to perform processing includes: storing, by every one of a plurality of threads, in a case where input packets include identification information of terminals, in a memory, identification information of sessions used for transmitting the input packets, in association with classification categories associated with the terminals and time information in the input packets; specifying, by every one of a plurality of classification threads that performs classification processing of the input packets, in a case where a target packet of the classification processing does not include identification information of a terminal that processes the target packet, classification categories associated with identification Information of a session used for transmitting the target packet and a time equal to or earlier than time information in the target packet, by referencing the memory; and classifying the target packet into a classification category associated with a relatively later time among the specified classification categories.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of packet classification processing;

FIG. 2 is a sequence diagram illustrating an example of packet classification processing according to an embodiment;

FIG. 3 is a diagram illustrating an example of a configuration of an Information processing apparatus;

FIG. 4 is a diagram illustrating an example of a hardware configuration of the Information processing apparatus;

FIG. 5 is a diagram illustrating an example of a network;

FIG. 6 is a diagram illustrating examples of a packet format;

FIG. 7 is a diagram illustrating an example of distribution of packet processing in parallel processing;

FIG. 8 is a diagram illustrating an example of map information and map auxiliary information;

FIG. 9 is a diagram illustrating an example of map information update processing;

FIG. 10 is a flowchart illustrating an example of processing of updating the map information and the map auxiliary Information;

FIG. 11 is a flowchart illustrating an example of processing of generating a mapping table;

FIG. 12 is a flowchart illustrating an example of merge processing;

FIG. 13 is a diagram illustrating an example of generating a mapping table;

FIG. 14 is a flowchart illustrating an example of packet classification processing;

FIG. 15 is a flowchart illustrating an example of a method of determining a classification category;

FIG. 16 is a diagram Illustrating an example of packet classification processing;

FIG. 17 is a diagram illustrating an example of a configuration of an information processing apparatus according to a second embodiment;

FIG. 18A is a flowchart illustrating an example of a search formula generation method;

FIG. 18B is a flowchart illustrating the example of the search formula generation method;

FIG. 19 is a diagram illustrating an example of the search formula generation method; and

FIG. 20 is a diagram illustrating an example of packet search processing.

### DESCRIPTION OF EMBODIMENTS

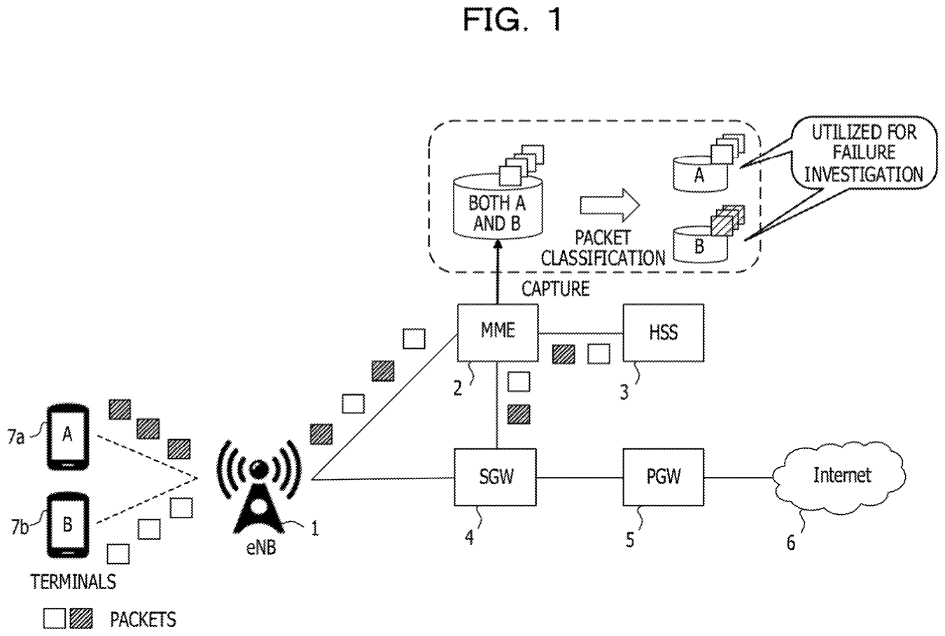

In a case where a failure has occurred in such a network, packets that have been captured in advance may be classified by terminal that transmits and receives the packets, and may be used to specify the cause. In the example in FIG. 1, the MME 2 captures packets transmitted from the eNB 1. In the example in FIG. 1, packets transmitted from the terminal 7b are indicated by empty boxes, and packets transmitted from the terminal 7a are Indicated by hatched boxes. When receiving packets from each of the terminals 7a and 7b, the eNB 1 forwards the received packets to the MME 2. Thus, the MME 2 receives a group of packets including both packets transmitted from the terminal 7a and packets transmitted from the terminal 7b. Here, each terminal 7 is identified by using an international mobile subscriber identity (IMSI). In the example in FIG. 1, the IMSI of the terminal 7a is A, and the IMSI of the terminal 7b is B. Packets transmitted from each terminal 7 include packets that include both an IMSI for identifying a transmission source and identification information of a session used for transmission and reception of the packets, and packets that do not include an IMSI but include only identification information of a session. A packet that does not include an IMSI is classified using information included in a previous packet processed before the packet, the information being a combination of the IMSI and identification information of a session. Thus, as illustrated in FIG. 1, each packet captured by the MME 2 may be classified in association with the transmission source.

Related technologies include a system that identifies a sequence by using information used for reproducing a sequence added to a received packet and a transmitted packet by a call processing device and payload consistency between the transmitted packet and the received packet. A system that collects packets forwarded in a packet network, divides the packets into groups in accordance with attribute information, determines a type of service corresponding to behavior of packets classified by group, and measures a quality index corresponding to the type of service has been proposed.

With the spread of the terminals 7, the amount of packets transmitted and received in a network is increasing. It is therefore desirable to shorten a time taken for packet classification by performing parallel processing of packets, and the like. However, in a case where the processing is performed in parallel, each thread is able to specify a classification category of a packet that does not include an IMSI, exclusively after processing a packet that includes both the IMSI and session identification information. Thus, in a case where a packet that includes both an IMSI and session identification Information is processed in a thread and a subsequent packet that does not include the IMSI is input to another thread, classification of the packet that does not include the IMSI will fail. Consequently, it is difficult to parallelize packet classification processing. Furthermore, even in a case where the technology described as a related technology is used, this problem is not solved.

It is an object of one aspect of the embodiments to parallelize packet classification processing.

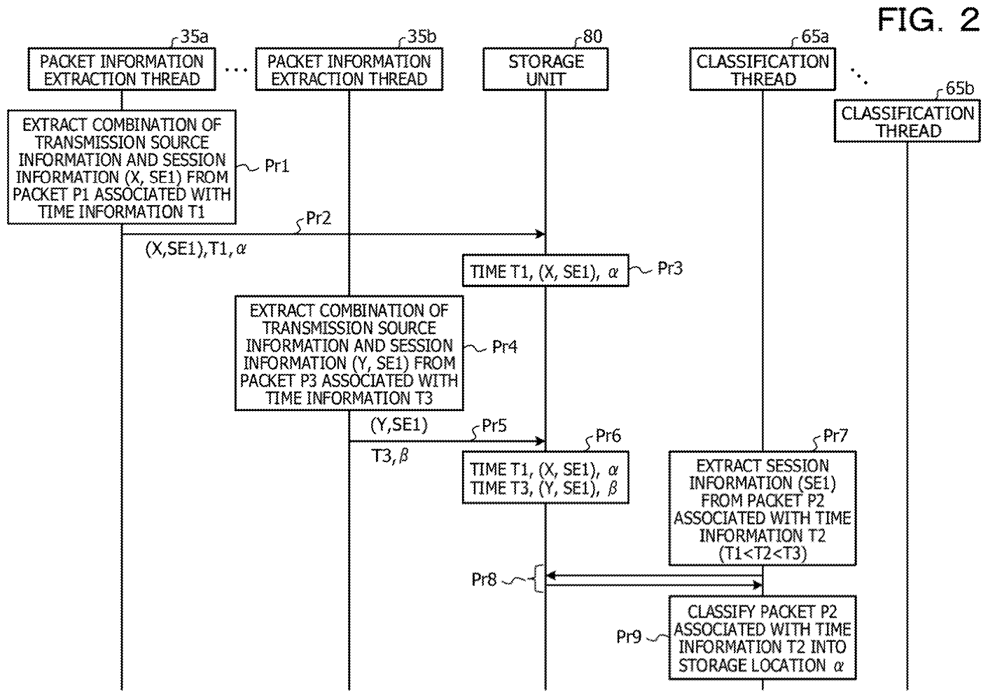

FIG. 2 is a sequence diagram illustrating an example of packet classification processing according to an embodiment. In a method according to the embodiment, transmission source identification information, session identification information, and time information included in a packet are extracted by parallel processing in a plurality of packet information extraction threads 35. In a case where information extracted from one packet includes a combination of transmission source identification information and session identification information, each packet information extraction thread 35 registers the extracted information in map information 81. For example, it is assumed that a packet information extraction thread 35a extracts a combination of transmission source information and session identification information (X, SE1) from a packet P1 associated with time information T1 (procedure Pr1). Then, the packet information extraction thread 35a stores the extracted information in a storage unit 80 shared with other threads, so that the other threads may access the extracted information. Furthermore, it is assumed that the packet information extraction thread 35a determines to store packets related to a packet transmission source X in a storage location α. The packet information extraction thread 35a causes the storage unit 80 to store each of the transmission source information and the session identification information (X, SE1) included in the packet P1 in association with a corresponding storage location determined in association with the time information T1 in the packet P1 and the transmission source X (procedure Pr2). The storage unit 80 stores a time T1 and the storage location a in association with (X, SE1) (procedure Pr3).

On the other hand, it is assumed that a packet information extraction thread 35b extracts a combination of transmission source information and session identification information (Y, SE1) from a packet P3 associated with time information T3 (procedure Pr4). Furthermore, it is assumed that the packet information extraction thread 35b determines to store packets related to a packet transmission source Y in a storage location β. Then, the packet information extraction thread 35b notifies the storage unit 80 of the combination of the transmission source information and the session Identification Information (Y, SE1) Included in the packet P3, the time information T3 in the packet P3, and the storage location β. (procedure Pr5). The storage unit 80 stores a time T3 and the storage location β in association with (Y, SE1). Thus, the storage unit 80 stores the following information:

the time T1, (X, SE1), α,

the time T3, (Y, SE1), and β (procedure Pr6).

In the method according to the embodiment, classification of packets is also processed in parallel by a plurality of classification threads 65 (65a and 65b). At this time, each classification thread 65 uses information stored in the storage unit 80 to classify packets. For example, it is assumed that the classification thread 65a acquires a packet P2 that Includes time information T2, as a target of classification processing. Here, it is assumed that a time T2 is after the time T1 and before the time T3 (T1<T2<T3). Furthermore, it is assumed that the packet P2 does not include transmission source identification information, but includes session identification information SE1. The classification threads 65 extracts the session identification information SE1 in the packet P2 (procedure Pr7). The classification thread 65a references the storage unit 80 to determine which transmission source the session identification information SE1 in the packet P2 is associated with at the time T2 (procedure Pr8). At the time of procedure Pr8, the session identification information SE1 is associated with two transmission sources, X and Y. Since the session Identification information SE1 is associated with the transmission source Y at the time T3, a session identified by the session identification information SE1 is used by Y from the time T3. On the other hand, since the session identification information SE1 is associated with the transmission source X at the time T1, a session identified by the session identification information SE1 is used by X from the time T1 to the time T3. Since the time information T2 in the packet P2 is after the time T1 and before the time T3, the classification thread 65a determines that the session identified by the session identification information SE1 was being used by the transmission source X at the time of transmission of the packet P2. Thus, the classification thread 65a classifies the packet P2 associated with the time information T2 into the storage location α associated with the transmission source X (procedure Pr9).

As described above, in the method according to the embodiment, extraction of information from packets and classification of the packets are performed in parallel by a plurality of threads. However, each of the packet information extraction threads 35 records the extracted information in the shared storage unit 80. Thus, even in a case where a processing target packet does not include information for identifying a transmission source, the classification threads 65 may specify the transmission source of the processing target packet by using information in the storage unit 80, and may classify the packet in association with the transmission source. Consequently, the method according to the embodiment uses a plurality of threads to perform parallel processing of a plurality of packets, thereby shortening a time taken for packet classification processing. Furthermore, even in a case where the processing is performed in parallel, information used for classifying packets is shared among threads. This allows for processing of all processing target packets, regardless of how the packets are allocated to the packet information extraction threads 35 or to each classification thread 65.

<Example of Apparatus Configuration and Network>

The following description takes as an example a case where the transmission source identification Information is an IMSI and General Packet Radio Service Tunneling Protocol (GTP) is used as a protocol for transmission and reception of packets. It is assumed that a combination of an Internet Protocol (IP) address and a tunnel endpoint identifier (TEID) is used as identification information of a session used for transmission and reception of packets. A combination of an IP address and a TEID used as session identification information may be hereinafter referred to as IP_TEID.

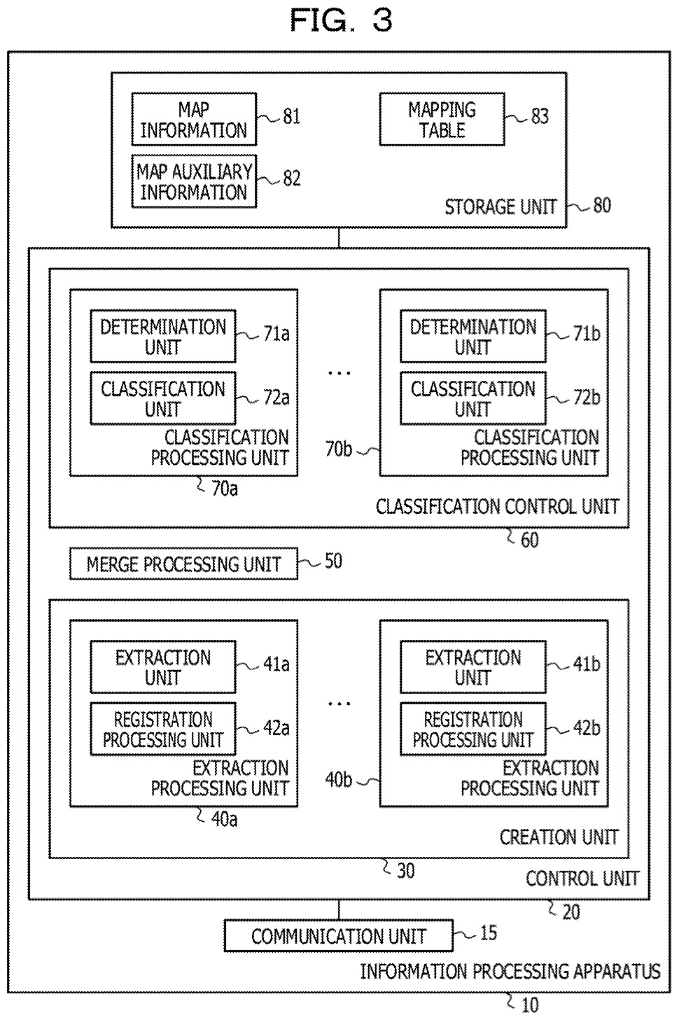

FIG. 3 is a diagram illustrating an example of a configuration of an Information processing apparatus 10. The information processing apparatus 10 includes a communication unit 15, a control unit 20, and the storage unit 80. The storage unit 80 includes the map information 81, map auxiliary information 82, and a mapping table 83. The map information 81 is information for mapping obtained from a packet that includes both an IMSI and session identification information used for transmission and reception of the packet. The map auxiliary information 82 is information obtained from analysis of a packet that includes identification information of a plurality of sessions. The mapping table 83 is generated by integrating information of both the map information 81 and the map auxiliary information 82.

The control unit 20 includes a creation unit 30, a merge processing unit 50, and a classification control unit 60. The creation unit 30 includes an extraction processing unit 40. While extraction processing units 40a and 40b are Illustrated in FIG. 3, the number of the extraction processing units 40 may be any number equal to or larger than one. Note that each extraction processing unit 40 may include a thread of a program that runs to extract information used for packet classification processing. The extraction processing unit 40 includes an extraction unit 41 (41a or 41b) and a registration processing unit 42 (42a or 42b). The extraction unit 41 extracts an IMSI, session identification information, and the like in an input packet, and also extracts time information in the packet. The registration processing unit 42 records, in the map information 81, information extracted from a packet that includes an IMSI. Moreover, the registration processing unit 42 registers, in the map auxiliary Information 82, information extracted from a packet that does not include an IMSI but includes a plurality of IP_TEIDs. The merge processing unit 50 generates the mapping table 83 by integrating the map information 81 and the map auxiliary information 82.

The classification control unit 60 includes a classification processing unit 70. While classification processing units 70a and 70b are illustrated in FIG. 3, the number of the classification processing units 70 may be any number equal to or larger than one. Each classification processing unit 70 may include a thread of a program that performs packet classification processing. The classification processing unit 70 includes a determination unit 71 (71a or 71b) and a classification unit 72 (72a or 72b). The determination unit 71 determines a classification category of a packet. The classification unit 72 classifies the packet into the classification category determined by the determination unit 71.

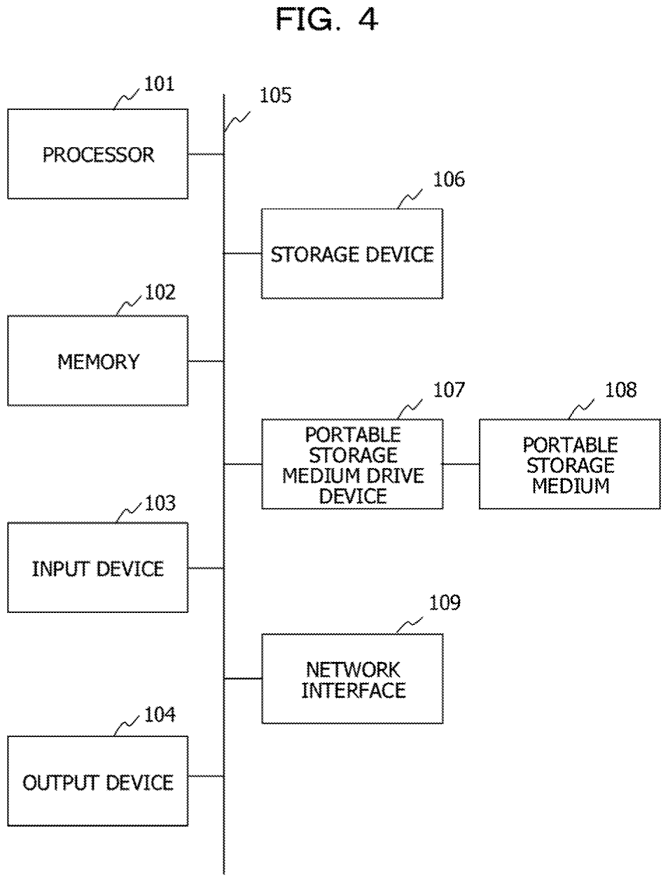

FIG. 4 is a diagram illustrating an example of a hardware configuration of the information processing apparatus 10. The information processing apparatus 10 includes a processor 101, a memory 102, a bus 105, and a network interface 109. Moreover, the information processing apparatus 10 may include an input device 103, an output device 104, a storage device 106 or a portable storage medium drive device 107 or any combination thereof. The information processing apparatus 10 may include, for example, a computer or a server device.

The processor 101 may be any processing circuit such as a central processing unit (CPU). The processor 101 may execute a program stored in the memory 102 or the storage device 106, for example. The memory 102 stores, as appropriate, data obtained by operation of the processor 101 and data used for processing by the processor 101. The storage device 106 stores programs, data, and the like, and provides the stored information to the processor 101 and the like as appropriate. The network interface 109 performs processing to allow the information processing apparatus 10 to communicate with another device.

The bus 105 connects the processor 101, the memory 102, the input device 103, the output device 104, the storage device 106, the portable storage medium drive device 107, and the network interface 109 so as to allow for mutual transmission and reception of data. The input device 103 may be any device used for input of information, such as a keyboard, a mouse, a microphone, or a camera. The output device 104 may be any device used for output of data, such as a display. The portable storage medium drive device 107 may output, to a portable storage medium 108, data in the memory 102 or the storage device 106, and may retrieve a program, data, or the like from the portable storage medium 108. Here, the portable storage medium 108 may be any portable storage medium Including a compact disc recordable (CD-R) and a digital versatile disk recordable (DVD-R).

In the information processing apparatus 10, the processor 101 operates as the control unit 20. The memory 102 and the storage device 106 operate as the storage unit 80. The network interface 109 operates as the communication unit 15.

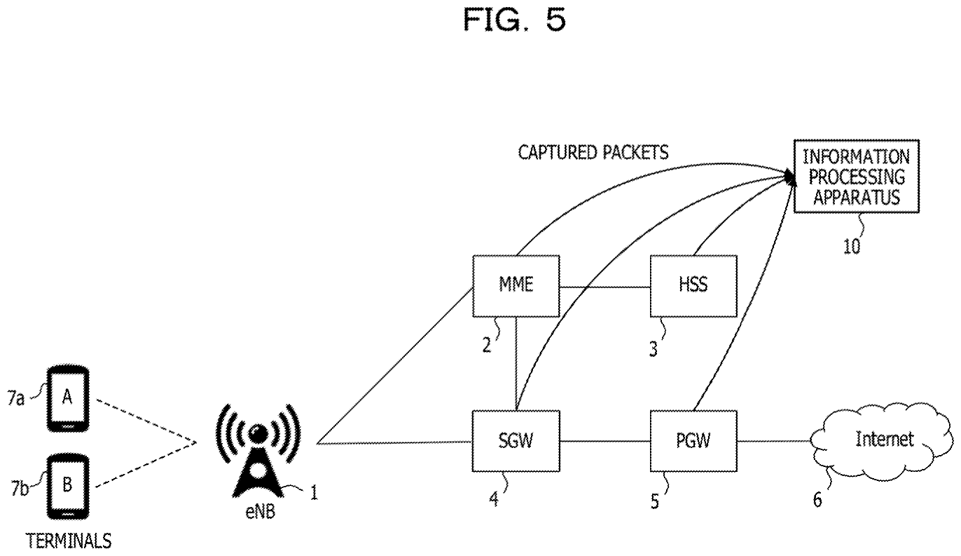

FIG. 5 is a diagram illustrating an example of a network. FIG. 5 also includes an LTE network similar to the network described with reference to FIG. 1. Also in FIG. 5, terminals 7a and 7b are connected to an eNB 1. Furthermore, the IMSI of the terminal 7a is A and the IMSI of the terminal 7b is B. The eNB 1 is connected to an MME 2 and an SGW 4, and the MME 2 is connected to an HSS 3 and the SGW 4. The SGW 4 is connected to Internet 6 via a PGW 5. The information processing apparatus 10 may be connected to the MME 2, the HSS 3, the SGW 4 or the PGW 5 or any combination thereof. From a device that captures packets, the device being one of the MME 2, the HSS 3, the SGW 4, or the PGW 5, the information processing apparatus 10 acquires packets captured by the device, and classifies the packets by terminal 7 that is the transmission source of the corresponding packet. Note that when a packet is captured, the device that has captured the packet adds, to the packet, a packet capture (pcap) header that includes Information of the time of capture of the packet.

### First Embodiment

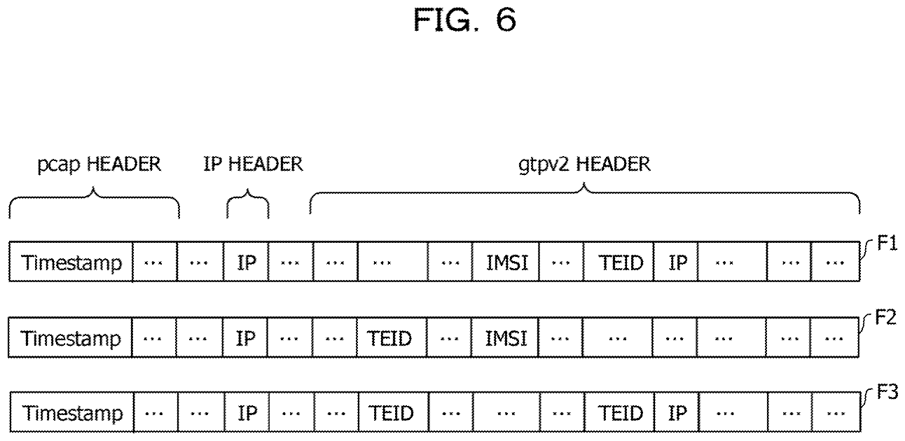

FIG. 6 is a diagram illustrating examples of a packet format. Packets transmitted and received in a network are classified into the following three types, in terms of whether an IMSI is included and the number of IP_TEIDs in the packet.

Type 1: An IMSI Is Included, and one IP_TEID is included.

Type 2: No IMSI is included, and one IP_TEID is included.

Type 3: No IMSI Is Included, and two IP_TEIDs are included.

A packet of any of these types includes a pcap header, an IP header, a gtpv2 header, and a payload. Note that payload portions are omitted in FIG. 6. Each pcap header includes a timestamp. Each timestamp indicates a time of capture of the corresponding packet.

F1 is an example of a format of a type 1 packet. The type 1 packet includes, in the gtpv2 header, an IMSI allocated to a terminal 7 that is the transmission source of the corresponding packet, an end point of a session, among end points of sessions used for communication, on the transmission source terminal side (source TEID), and an IP address of the transmission source. Note that the IP header includes an IP address of the transmission source of the packet and an IP address of a destination. The type 1 packet may be used to request for a session start or the like.

F2 is an example of a format of a type 2 packet. The type 2 packet includes, in the gtpv2 header, an end point of a session, among end points of sessions used for communication, on the destination terminal side (destination TEID). In other words, for example, the type 2 packet includes destination address information in the IP header and an IP_TEID on the packet destination side. The type 2 packet may be used for communication after establishment of a session.

F3 is an example of a format of a type 3 packet. The type 3 packet includes, in the gtpv2 header, an end point of a session on the transmission source terminal side before a change in session used for communication, an end point of a session on the transmission source terminal side after the change in session, and an IP address of the transmission source. In other words, for example, the gtpv2 header and the IP header of the type 3 packet may be used to specify IP_TEIDs before and after the change in IP_TEID on the packet transmission source side. The type 3 packet may be used as a packet transmitted and received at the time of response to a session start or moving of a node.

Examples of processing performed by an information processing apparatus 10 will be described below, separately in (1) extraction and registration of information in packets, (2) generation of a mapping table 83, and (3) packet classification processing.

(1) Extraction and Registration of Information in Packets

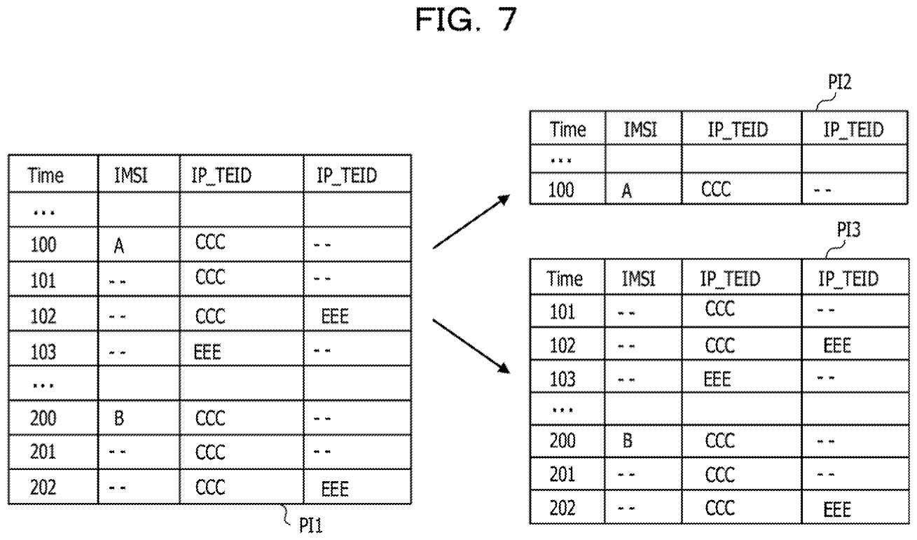

FIG. 7 is a diagram illustrating an example of distribution of packet processing in parallel processing. Described below is a case where extraction of information from a group of processing target packets is performed in parallel by extraction processing units 40a and 40b. Note that both of the extraction processing units 40a and 40b may update map information 81 and map auxiliary information 82 in a storage unit 80.

A group of packets to be classified is illustrated in PI1. In the following drawings, only a timestamp, whether an IMSI is included, and an IP_TEID are illustrated for each packet for better visibility. The example in PI1 includes packets associated with Time 202 or earlier. Here, it is assumed that, of the packets illustrated in PI1, packets associated with Time 100 or earlier are processed by the extraction processing unit 40a, and packets associated with Times 101 to 202 are processed by the extraction processing unit 40b. PI2 illustrates a group of packets to be processed by the extraction processing unit 40a, and PI3 illustrates a group of packets to be processed by the extraction processing unit 40b.

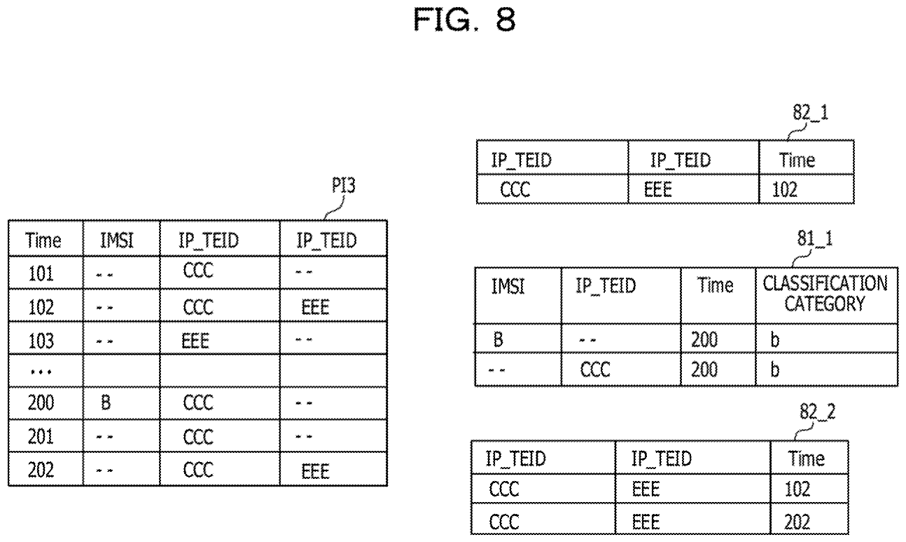

FIG. 8 is a diagram illustrating an example of the map information 81 and the map auxiliary information 82 obtained by processing by the extraction processing unit 40b. An extraction unit 41b extracts an IMSI, an IP_TEID, and time information from a type 1 packet, and extracts two IP_TEIDs and time information from a type 3 packet. On the other hand, the extraction unit 41b does not perform extraction processing on a type 2 packet. Furthermore, a registration processing unit 42b registers the Information extracted by the extraction unit 41b in the map information 81 or the map auxiliary information 82. For example, it is assumed that the extraction unit 41b and the registration processing unit 42b process the packets illustrated in PI3 in ascending order of the value of Time.

Since the packet associated with Time 101 is a type 2 packet, neither the extraction unit 41b nor the registration processing unit 42b processes the packet associated with Time 101. Since the packet associated with Time 102 is a type 3 packet, the extraction unit 41b extracts the following information.

Time: 102

IP_TEID: CCC

IP_TEID: EEE

Since the extracted information does not include an IMSI, the registration processing unit 42b registers the extracted information in the map auxiliary information 82. As a result of the registration processing by the registration processing unit 42b, the map auxiliary information 82 is updated as illustrated in map auxiliary information 82_1 in FIG. 8. The map auxiliary information 82 includes a combination of two IP_TEIDs and time information included in one packet.

Since the packet associated with Time 103 is a type 2 packet, neither the extraction unit 41b nor the registration processing unit 42b processes the packet associated with Time 103. The packet associated with Time 200 is a type 1 packet. Thus, the extraction unit 41b extracts the following information from the packet associated with lime 200.

Time: 200

IMSI: B

IP_TEID: CCC

Since the extracted information includes an IMSI, the registration processing unit 42b registers the extracted information in the map information 81. At the time of registration, it is assumed that the registration processing unit 42b determines b as a classification category of packets of a terminal 7 identified by the IMSI B. The map information 81 includes IMSIs, IP_TEIDs, time Information (Time), and classification categories. At the time of registration in the map information 81, the registration processing unit 42b associates an IMSI and an IP_TEID individually as separate entries with time information and a classification category. Thus, the registration processing unit 42b registers the following information for the IMSI B.

Time: 200

IMSI: B

Classification category: b

As illustrated in the packet associated with Time 200, the IP_TEID CCC is included in the packet that includes the IMSI B. Thus, at Time 200 or later, the classification category of packets associated with the IP_TEID CCC is also b, which is the same as the classification category of the packet that includes the IMSI B. Consequently, the following information is registered for the IP_TEID CCC.

Time: 200

IP_TEID: CCC

Classification category: b

The registration processing unit 42b registers the information extracted from the packet associated with Time 200, thereby updating the map information 81 as illustrated in map information 81_1 in FIG. 8.

Since the packet associated with Time 201 is a type 2 packet, neither the extraction unit 41b nor the registration processing unit 42b processes the packet associated with Time 201. Since the packet associated with Time 202 is a type 3 packet, extraction processing by the extraction unit 41b and registration processing by the registration processing unit 42b are performed in a similar manner to the processing for the packet associated with Time 102. Thus, when the information in the packet associated with Time 202 is registered, the map auxiliary information 82_1 is updated as illustrated in map auxiliary information 82_2.

While the processing of some of the processing target packets by the extraction processing unit 40b has been described with reference to FIG. 8, other packets are also processed in a similar manner in accordance with the type of packet.

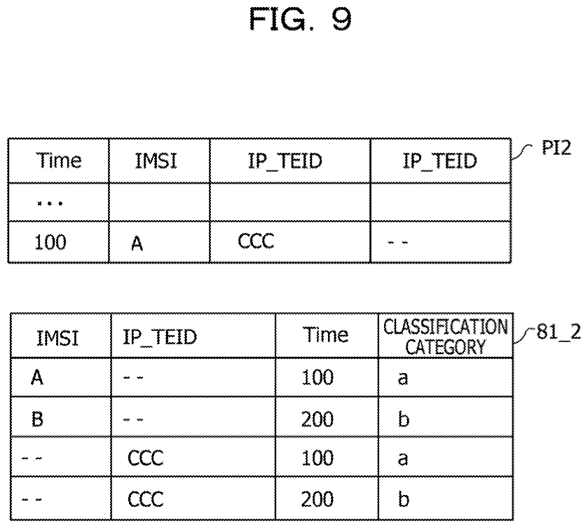

FIG. 9 is a diagram illustrating an example of map information update processing performed by the extraction processing unit 40a. In a similar manner to the extraction processing unit 40b, the extraction processing unit 40a processes packets associated with Time 100 or earlier included in P12. All packets associated with Time 99 or earlier are assumed to be type 2 packets. Thus, when processing packets associated with Time 99 or earlier, the extraction processing unit 40a updates neither the map information 81 nor the map auxiliary information 82. Thus, it is assumed that the map information 81_1 and the map auxiliary information 82_2 (FIG. 8) are retained in the storage unit 80 when the packet associated with Time 100 is processed.

Since the packet associated with Time 100 is a type 1 packet, the extraction unit 41a extracts the following information.

Time: 100

IMSI: A

IP_TEID: CCC

Since the extracted information includes an IMSI, a registration processing unit 42a registers the following information for each of the IMSI and the IP_TEID. Note that it is assumed that the registration processing unit 42a determines a as a classification category of packets used by the transmission source identified by the IMSI A.

Time: 100

IMSI: A

Classification category: a

As illustrated in the packet associated with Time 100, the IP_TEID CCC is included in the packet that includes the IMSI A. Thus, at Time 100 or later and before a terminal 7 other than a terminal 7 identified by the IMSI A starts using the IP_TEID CCC, the classification category of packets that include the IP_TEID CCC is also a, which is the same as the classification category of the packet that includes the IMSI A. Consequently, the following information is registered for the IP_TEID CCC.

Time: 100

IP_TEID: CCC

Classification category: a

The registration processing unit 42a registers the information extracted from the packet associated with Time 100, thereby updating the map information 81_1 in FIG. 8 as illustrated in map information 81_2 in FIG. 9.

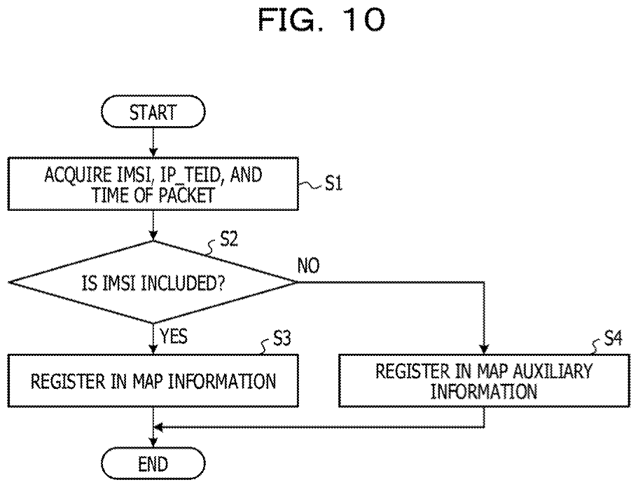

FIG. 10 is a flowchart illustrating an example of processing of updating the map information and the map auxiliary Information. The processing in FIG. 10 may be performed in parallel by one or more extraction processing units 40. The extraction unit 41 acquires an IMSI, an IP_TEID, and time information of a processing target packet (step S1). Note that acquisition of an IMSI is performed in a case where the processing target packet is a type 1 packet that includes an IMSI. A registration processing unit 42 determines whether the extracted information includes an IMSI (step S2). In a case where the extracted information includes an IMSI (Yes in step S2), the registration processing unit 42 registers the extracted information in the map information 81 (step S3). In a case where the extracted information does not include an IMSI (No in step S2), the registration processing unit 42 registers the extracted Information in the map auxiliary Information 82 (step S4).

(2) Generation of Mapping Table 83

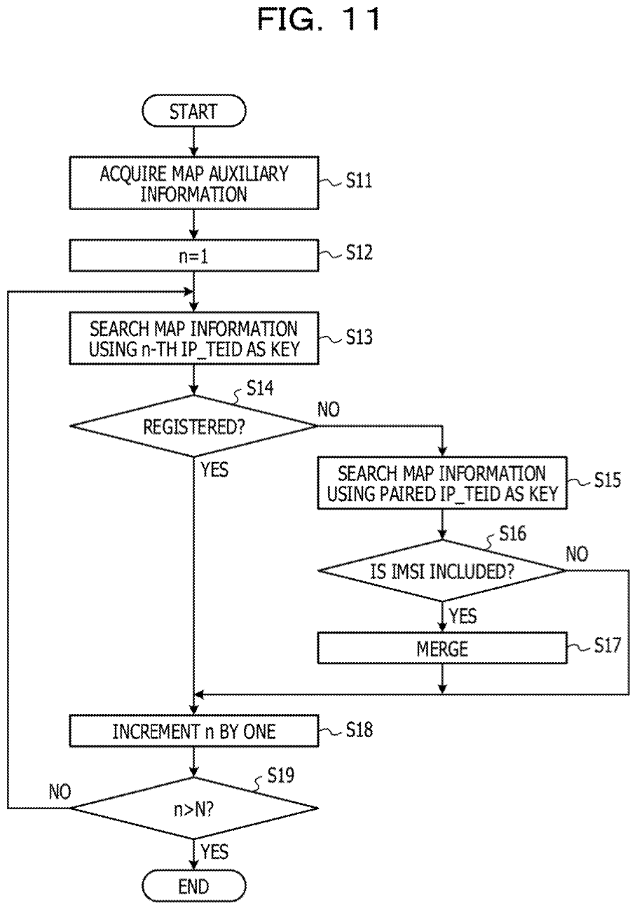

FIG. 11 is a flowchart illustrating an example of processing of generating a mapping table 83. The mapping table 83 is generated by a merge processing unit 50. In FIG. 11, a variable n and a constant N are used. The variable n is used for counting the number of IP_TEIDs that have been set as processing targets. N is the total number of IP_TEIDs registered in the map auxiliary information 82. Note that FIG. 11 is an example of the processing, and the processing may be modified according to the Implementation. For example, the order of steps S11 and S12 may be arbitrarily changed.

The merge processing unit 50 acquires the map auxiliary information 82 (step S11). At this time, the merge processing unit 50 copies, into the mapping table 83, the latest map information 81 at the time of start of the generation of the mapping table 83. Next, the merge processing unit 50 sets the variable n to 1 (step S12). The merge processing unit 50 searches the map information 81 using an n-th IP_TEID as a key (step S13). The merge processing unit 50 determines whether the n-th IP_TEID has already been registered in the map information 81 (step S14).

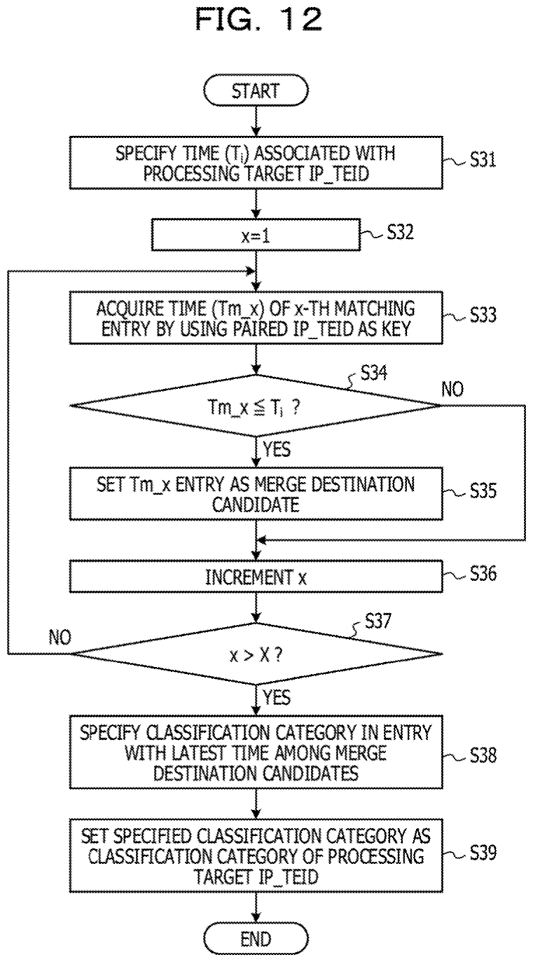

In a case where the n-th IP_TEID has not been registered in the map information 81 (No in step S14), the map information 81 is searched using, as a key, an IP_TEID in the map auxiliary information 82, the IP_TEID being paired with the n-th IP_TEID (step S15). In a case where the IP_TEID that is paired with the n-th IP_TEID has been registered in the map information 81 (Yes in step S16), the merge processing unit 50 performs merge processing (step S17). In the merge processing, the classification category of the packet that includes the n-th IP_TEID is set to the same classification category as the packet that includes the IP_TEID that is paired with the n-th IP_TEID, and thus the classification categories of the packets are integrated. In order to perform the merge processing, the merge processing unit 50 records a processing target IP_TEID in the mapping table 83 in association with the same classification category as a classification category in an entry of a merge destination. Details of the merge processing will be described with reference to FIG. 12. Thereafter, the merge processing unit 50 increments the variable n by one, and then compares the variable n with the constant N (steps S18 and S19). In a case where the variable n is equal to or smaller than the constant N, the processing for all IP_TEIDs has not been completed, and the processing from step S13 is repeated (No in step S19). On the other hand, in a case where the variable n exceeds the constant N, the processing for all IP_TEIDs has been completed, and the merge processing unit 50 ends the processing (Yes in step S19).

In a case where neither the n-th IP_TEID nor the IP_TEID that is paired with the n-th IP_TEID has been registered in the map Information 81, the processing from step S18 is performed (No in step S16). Furthermore, also in a case where the n-th IP_TEID has already been registered, the processing from step S18 is performed (Yes in step S14).

FIG. 12 is a flowchart illustrating an example of the merge processing. FIG. 12 illustrates details of the processing performed in step S17 in FIG. 11. In FIG. 12, a variable x and a constant X are used. The variable x is used for counting the number of entries in the map information 81 that have been set as processing targets. The constant X is the total number of entries returned by a search using an IP_TEID that is paired with a processing target IP_TEID. Note that FIG. 12 is an example of the processing, and the processing may be modified according to the implementation. For example, the order of steps S31 and S32 may be arbitrarily changed.

The merge processing unit 50 specifies a time (Ti) associated with the merge processing target IP_TEID (step S31). The merge processing unit 50 sets the variable x to 1 (step S32). The merge processing unit 50 acquires a time (Tm_x) of an x-th matching entry by searching the map information 81 using, as a key, an IP_TEID in the map auxiliary information 82, the IP_TEID being paired with the processing target IP_TEID (step S33). The merge processing unit 50 determines whether the time Tm_x is equal to or earlier than the time Ti associated with the processing target IP_TEID (step S34). In a case where the time Tm_x is later than the time Ti, a classification category in the x-th entry is not used as a classification category of packets associated with the processing target IP_TEID (No in step S34). Thus, the merge processing unit 50 increments the variable x, and compares the variable x with the constant X (steps S36 and S37). In a case where the variable x is equal to or smaller than the constant X, the time information comparison processing has not been performed for all the entries returned by the search using the IP_TEID that is paired with the processing target IP_TEID (No in step S37). Thus, the processing from step S33 is performed.

In a case where the time Tm_x is equal to or earlier than the time Ti (Yes in step S34), the merge processing unit 50 sets an entry that includes the time Tm_x as a candidate for the merge destination (step S35). Here, the merge destination is an entry that integrates classification categories of packets that include the processing target IP_TEID. The merge processing unit 50 increments the variable x, and performs the processing from step S37 (steps S36 and S37).

In a case where the variable x exceeds the constant X, the merge processing unit 50 has performed the time information comparison processing for all the entries returned by the search using the IP_TEID that is paired with the processing target IP_TEID (Yes in step S37). Thus, the merge processing unit 50 specifies a classification category in an entry with a time that is the latest among candidates for the merge destination, and sets the specified classification category as a classification category of the processing target IP_TEID (steps S38 and S39). In step S39, the merge processing unit 50 records the processing target IP_TEID in the mapping table 83 in association with the specified classification category.

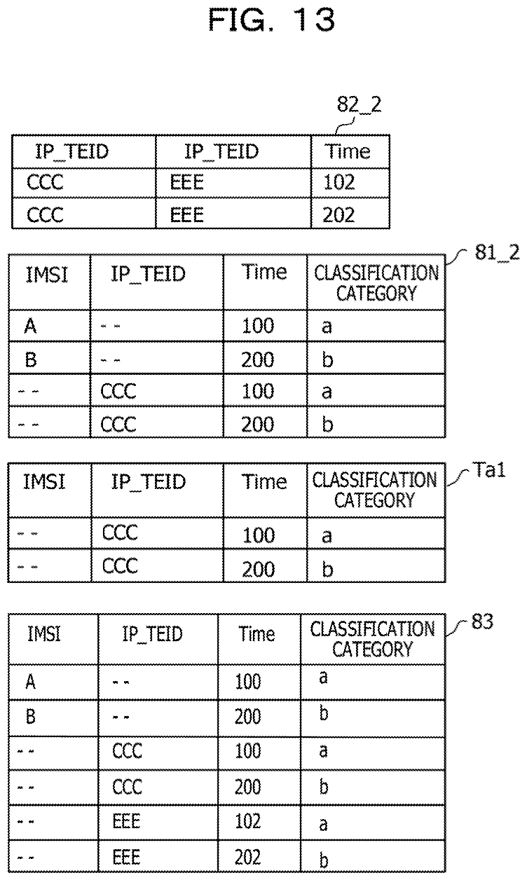

FIG. 13 is a diagram illustrating an example of generating a mapping table. A specific example of the processing illustrated in the flowcharts in FIGS. 11 and 12 will be described with reference to FIG. 13. The merge processing unit 50 processes each IP_TEID included in the map auxiliary information 82_2. Here, an IP_TEID CCC and an IP_TEID EEE have been registered for each of Time 102 and Time 202 in the map auxiliary information 82_2. In a case where the time information is different, different merge destinations may be set for the same IP_TEID. Thus, the merge processing unit 50 sets entries having the same IP_TEID but different times as separate processing targets. Thus, the merge processing unit 50 recognizes four types of combination of an IP_TEID and time Information in the map auxiliary Information 82_2.

First, it is assumed that the merge processing unit 50 sets a combination of Time 102 and the IP_TEID CCC as a processing target. At this time, the mapping table 83 includes the same information as the map information 81_2. Since the IP_TEID CCC has been registered in the map information 812, the merge processing unit 50 sets another combination of time information and an IP_TEID as a processing target (Yes in step S14 in FIG. 11). In a case where a combination of Time 202 and the IP_TEID CCC is set as a processing target, the merge processing unit 50 performs processing in a similar manner.

Next, it is assumed that the merge processing unit 50 sets a combination of Time 102 and the IP_TEID EEE as a processing target. In this case, the IP_TEID EEE has not been registered in the map information 81 (No in step S14 in FIG. 11). Thus, the merge processing unit 50 searches the map information 81_2 using, as a key, the IP_TEID CCC that is paired with the IP_TEID EEE in the map auxiliary information 82_2 (step S15 in FIG. 11). The entries returned by this processing are illustrated in Table Ta1 in FIG. 13. Table Ta1 includes two entries. In this case, the constant X used in FIG. 12 is 2. Since the time information associated with the processing target IP_TEID is Time 102, the merge processing unit 50 sets Ti to 102. Since the time (Tm_1) of the first entry in Table Ta1 is 100 and Tm_1 is smaller than Ti, the merge processing unit 50 sets the first entry as a candidate for the merge destination (steps S33 to S35 in FIG. 12). On the other hand, in the second entry, since the time (Tm_2) is 200 and Tm_2 is larger than Ti, the merge processing unit 50 does not set the second entry as a candidate for the merge destination (No in step S34 in FIG. 12). Since one candidate for the merge destination has been set, the merge processing unit 50 sets the first entry in Table Ta1 as the merge destination for the combination of Time 102 and the IP_TEID EEE, and associates the combination of Time 102 and the IP_TEID CCC with a classification category a. The merge processing unit 50 records the obtained result as Illustrated in the fifth entry from the top of the mapping table 83 in FIG. 13.

Moreover, it is assumed that the merge processing unit 50 sets a combination of Time 202 and the IP_TEID EEE as a processing target. Also in this case, since the IP_TEID EEE has not been registered in the map information 81, the merge processing unit 50 searches the map information 81_2 using, as a key, the IP_TEID CCC that is paired with the IP_TEID EEE in the map auxiliary information 82_2. Consequently, also in this case, Table Ta1 is obtained by the processing of step S15 in FIG. 11. Since the time information associated with the processing target IP_TEID Is Time 202, the merge processing unit 50 sets Ti to 202. Since the time (Tm_1) of the first entry in Table Ta1 is 100 and Tm_1 is smaller than Ti, the merge processing unit 50 sets the first entry as a candidate for the merge destination. Moreover, in the second entry, since the time (Tm_2) is 200 and Tm_2 is smaller than Ti, the merge processing unit 50 also sets the second entry as a candidate for the merge destination. Since two candidates for the merge destination have been set, the merge processing unit 50 sets, as the merge destination, an entry associated with a time that is the latest among the candidate entries (step S38 in FIG. 12). As a result, the merge destination is set to the second entry in Table Ta1. The merge processing unit 50 sets the classification category for the combination of Time 202 and the IP_TEID EEE to b, which is the same as the storage location in the second entry in Table Ta1. Moreover, the merge processing unit 50 records the obtained result as illustrated in the entry at the bottom of the mapping table 83 in FIG. 13.

As described with reference to FIGS. 11 to 13, the mapping table 83 is generated from the map information 81 and the map auxiliary information 82 by the processing by the merge processing unit 50. Thus, after the mapping table 83 has been generated, classification categories for all of the IMSIs and the IP_TEIDs used in captured packets are registered in the mapping table 83.

(3) Packet Classification

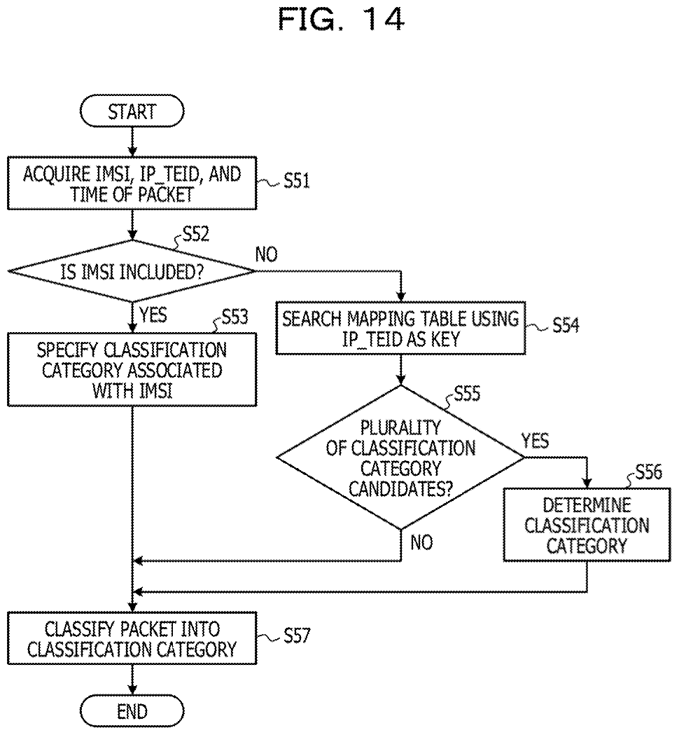

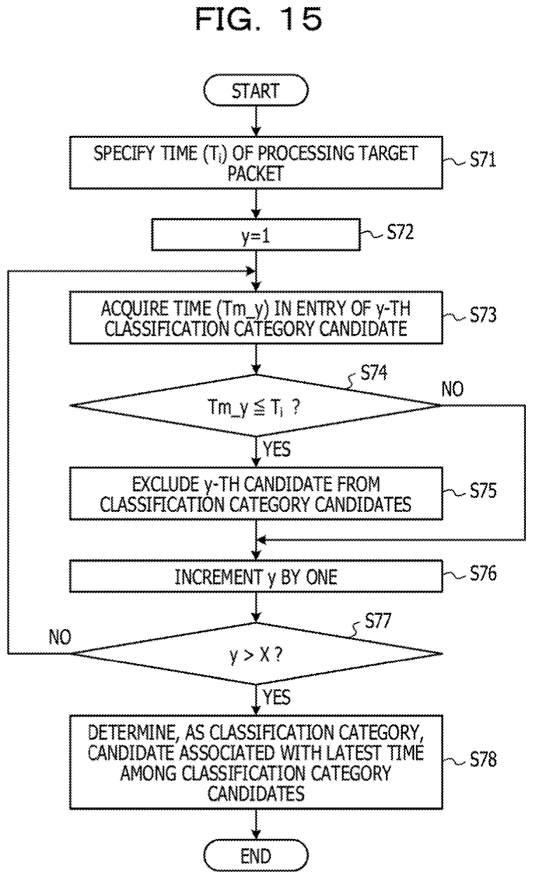

FIG. 14 is a flowchart illustrating an example of packet classification processing. Described below is a case where the packet classification processing is performed in parallel by classification processing units 70a and 70b. Both of the classification processing units 70a and 70b may reference the mapping table 83 in the storage unit 80, and perform the processing described with reference to FIGS. 14 and 15.

A classification unit 72 acquires an IMSI, an IP_TEID, and time information of a processing target packet (step S51). Note that acquisition of an IMSI is performed in a case where the processing target packet is a type 1 packet that includes an IMSI. The classification unit 72 determines whether the acquired information includes an IMSI (step S52). In a case where the acquired information includes an IMSI (Yes in step S52), the classification unit 72 specifies a classification category associated with the IMSI by referencing the mapping table 83 (step S53). The classification unit 72 classifies the processing target packet into the classification category (step S57).

On the other hand, in a case where the information acquired from the processing target packet does not include an IMSI (No in step S52), the classification unit 72 searches the mapping table 83 using the IP_TEID as a key (step S54). The classification unit 72 determines whether a plurality of classification category candidates has been obtained by the search (step S55). In a case where a plurality of classification category candidates has not been obtained (No in step S55), the classification unit 72 classifies the processing target packet into the obtained classification category (step S57). In a case where a plurality of classification category candidates has been obtained (Yes in step S55), a determination unit 71 chooses a classification category from the plurality of classification category candidates (step S56). The determination unit 71 notifies the classification unit 72 of the obtained classification category. Then, the classification unit 72 classifies the processing target packet into the classification category notified by the determination unit 71 (step S57).

FIG. 15 is a flowchart illustrating an example of a method of determining a classification category. FIG. 15 illustrates details of the processing performed in step S56 in FIG. 14. In FIG. 15, a variable y and a constant Y are used. The variable y is used for counting the number of classification category candidates that have been set as processing targets. The constant Y is the total number of classification category candidates returned by the search in step S54 in FIG. 14. Note that FIG. 15 is an example of the processing, and the processing may be modified according to the implementation. For example, the order of steps S71 and S72 may be arbitrarily changed.

The determination unit 71 specifies time information (Ti) of a processing target packet (step S71). At this time, the determination unit 71 may acquire, from the classification unit 72, the time information extracted from the packet by the classification unit 72, along with information of a plurality of classification categories. The determination unit 71 sets the variable y to 1 (step S72). The determination unit 71 references the mapping table 83 as appropriate and acquires the time (Tm_y) in an entry of a y-th classification category candidate (step S73). The determination unit 71 determines whether the time in the entry of the y-th classification category candidate is equal to or earlier than the time information in the processing target packet, in other words, for example, whether Tm_y is equal to or smaller than T (step S74). In a case where the time in the entry of the y-th classification category candidate is later than the time information in the processing target packet (No in step S74), there is no possibility of the processing target packet being classified into the classification category candidate, so the determination unit 71 excludes the y-th candidate from the classification category candidates (step S75). On the other hand, in a case where the time in the entry of the y-th classification category candidate is equal to or earlier than the time information in the processing target packet, it is determined that there is a possibility of the processing target packet being classified into the classification category candidate (Yes in step S74).

After the processing of step S75, or in a case where the determination result in step S74 is “Yes”, the determination unit 71 increments the variable y by one, and then compares the variable y with the constant Y (steps S76 and S77). In a case where the variable y does not exceed the constant Y, there is a classification category candidate that has not been set as a processing target, so the determination unit 71 repeats the processing from step S73 (No in step S77). On the other hand, in a case where the variable y exceeds the constant Y, the determination unit 71 determines that all the classification category candidates have been set as processing targets (Yes in step S77). Any candidate remaining as a classification category candidate after all the classification category candidates have been set as processing targets is a classification category that is associated with the IP_TEID included in the processing target packet, and is also associated with a time equal to or earlier than the time information in the processing target packet Thus, the determination unit 71 determines, as the classification category, a candidate associated with a time that is the latest among the classification category candidates (step S78).

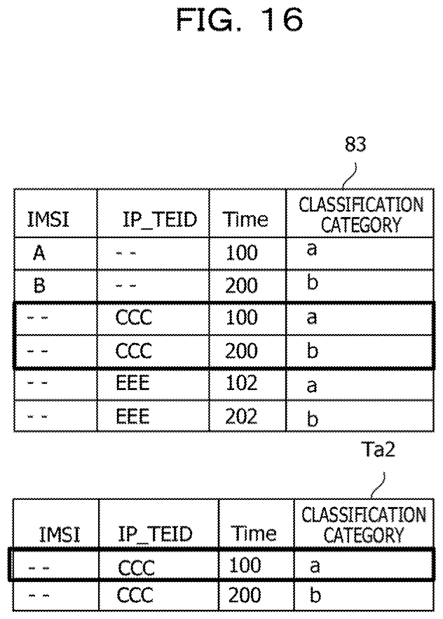

FIG. 16 is a diagram illustrating an example of packet classification processing. A specific example of the processing illustrated in the flowcharts in FIGS. 14 and 15 will be described with reference to FIG. 16. For example, it is assumed that a packet associated with Time 101 is a target of classification processing by the classification processing unit 70b, and the mapping table 83 is as illustrated in FIG. 16. Here, it is assumed that the packet associated with Time 101 includes the following Information.

Time: 101

IMSI: None

IP_TEID: CCC

A classification unit 72b searches the mapping table 83 using the IP_TEID CCC as a key. Then, since two entries illustrated in Table Ta2 are returned, the classification categories included one in each of the two entries in Table Ta2 are set as classification category candidates for the processing target. Since there is a plurality of classification category candidates, processing by a determination unit 71b is performed. The determination unit 71b excludes, from the classification category candidates, a classification category associated with a time later than time information (Time 101) included in the processing target packet. Since time information included in a classification category in a second entry in Table Ta2 is Time 200, the determination unit 71b excludes, from the classification category candidates, the classification category in the second entry in Table Ta2. In this case, the classification categories for the processing target packet are narrowed down to the classification category a in a first entry in Table Ta2, so the determination unit 71b determines the classification category a as the packet classification category. Then, the classification unit 72b classifies the processing target packet into the classification category a. Consequently, the packet associated with Time 101 is associated with a terminal 7a identified by the IMSI A.

As another example, an example of a case in which a packet associated with Time 201 is classified by the classification processing unit 70a will be described. It is assumed that the packet associated with Time 201 includes the following information.

Time: 201

IMSI: None

IP_TEID: CCC

Since a classification unit 72a searches the mapping table 83 using the IP_TEID CCC as a key, the classification categories Included one in each of the two entries in Table Ta2 are set as classification category candidates for the processing target. Also in this case, since there is a plurality of classification category candidates, processing by a determination unit 71a is performed. The determination unit 71a excludes, from the classification category candidates, a classification category associated with a time later than time information (Time 201) included in the processing target packet. However, both of the entries in Table Ta2 have time information equal to or earlier than Time 201. The classification category candidates are not narrowed down to one by using the time information in the packet, so the determination unit 71a determines, as the classification category of the processing target packet, a classification category b in an entry with time information that is the latest among the entries in Table Ta2. Thus, the classification unit 72a classifies the packet that includes Time 201 into the classification category b. Consequently, the packet associated with Time 201 is associated with a terminal 7b identified by the IMSI B.

As described above, in the method according to the embodiment, even in a case where extraction of information from packets and classification of packets are performed in parallel by a plurality of threads, the mapping table 83 used for the classification of the packets is retained in the storage unit 80 that may be accessed by each thread. Thus, even in a case where none of the processing target packets include an IMSI, each classification processing unit 70 may specify a classification category of a processing target packet by using Information in the storage unit 80. Furthermore, the classification category is associated with a terminal 7 that is performing communication using the packet. Consequently, the method according to the embodiment uses a plurality of threads to perform parallel processing of a plurality of packets, thereby shortening a time taken for packet classification processing. Furthermore, even in a case where the processing is performed in parallel, information used for classifying packets is shared among threads. This allows for processing of all processing target packets, regardless of how the packets are allocated to each classification processing unit 70. Consequently, by using the Information processing apparatus 10 according to the embodiment, information to be used for analysis of a failure that has occurred in a network may be obtained more quickly.

### Second Embodiment

In a second embodiment, a description will be given of a case where the efficiency of acquiring information to be used for analysis of a failure that has occurred in a network is further improved by limiting targets of classification processing to packets transmitted and received by a specific terminal 7. In other words, for example, in the second embodiment, the targets of classification processing may be limited to packets that may be classified into the same classification category as a specific IMSI.

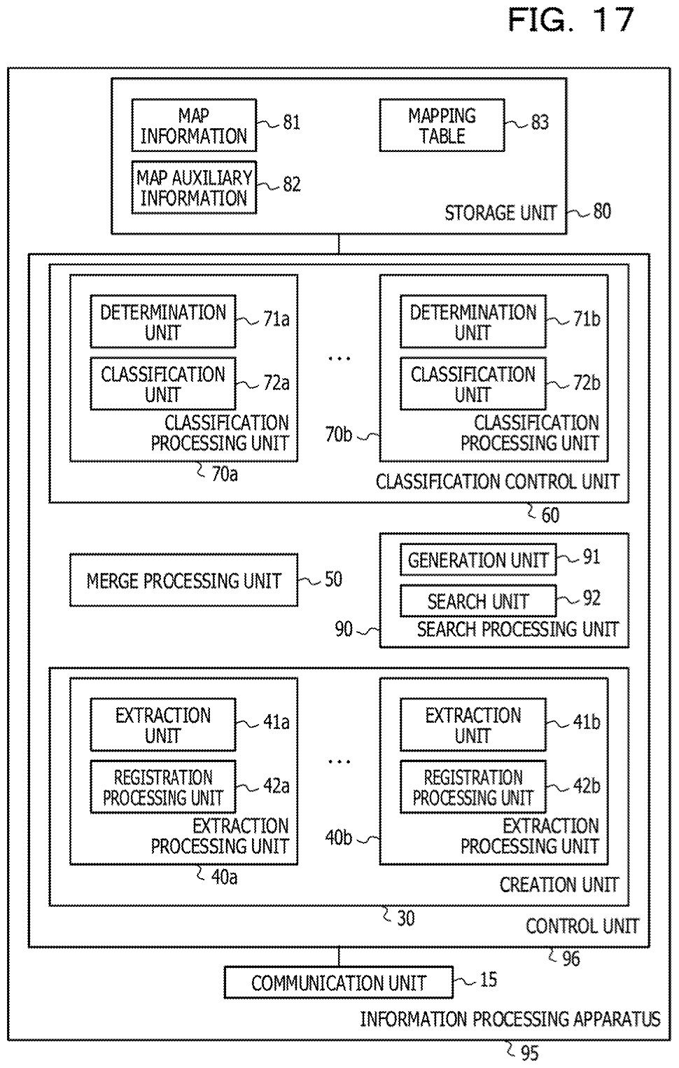

FIG. 17 is a diagram illustrating an example of a configuration of an information processing apparatus 95 according to the second embodiment. The information processing apparatus 95 includes a communication unit 15, a control unit 96, and a storage unit 80. The control unit 96 includes a search processing unit 90, and further includes a creation unit 30, a merge processing unit 50, and a classification control unit 60. Processing performed by the communication unit 15, the creation unit 30, and the merge processing unit 50 in the second embodiment is similar to the processing in the first embodiment. Moreover, also in the second embodiment, the storage unit 80 retains map information 81, map auxiliary information 82, and a mapping table 83 as in the first embodiment, and may be accessed from any processing unit in the control unit 96.

The search processing unit 90 includes a generation unit 91 and a search unit 92. The generation unit 91 generates a search formula for specifying a packet to be analyzed. Note that, for example, the generation unit 91 receives an IMSI input by an operator via an input device 103, and generates a search formula for processing a packet associated with the same classification category as the input IMSI. The search unit 92 searches for a packet that matches the search formula generated by the generation unit 91, and outputs the obtained packet to the classification control unit 60. The classification control unit 60 includes classification processing units 70, each of which performs classification processing on packets input from the search unit 92. Note that the classification processing performed by the classification processing units 70 is similar to the classification processing in the first embodiment.

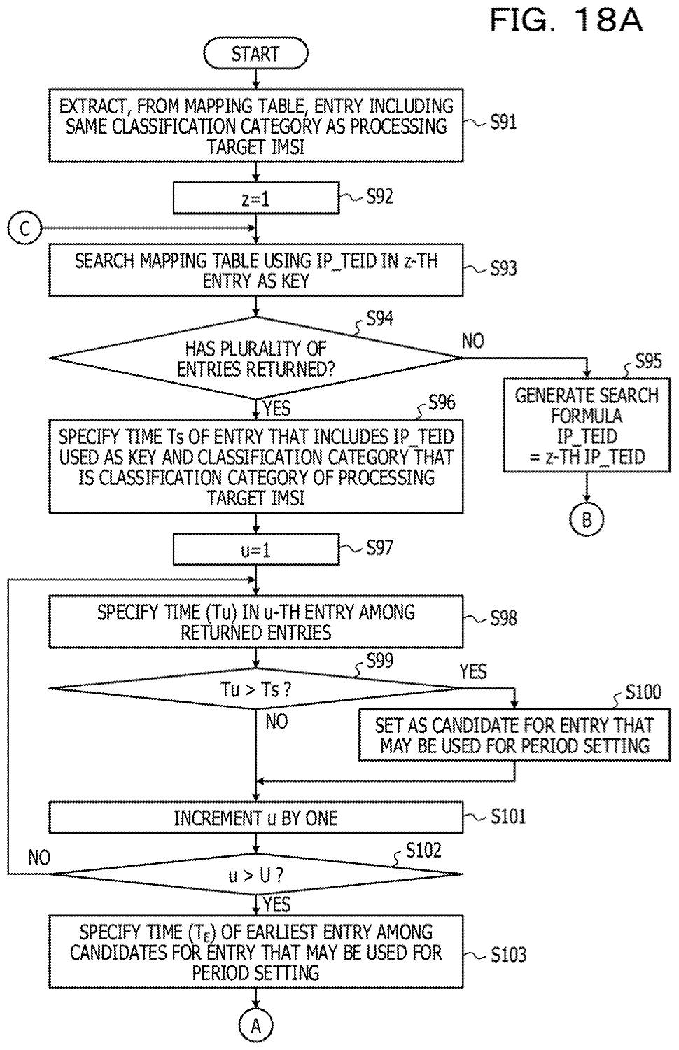

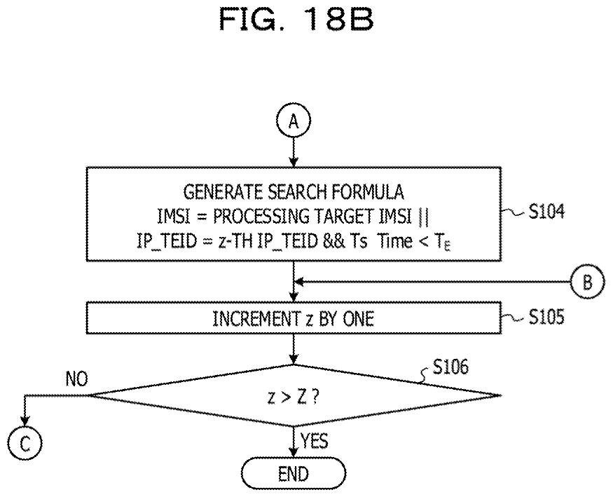

FIGS. 18A and 18B are flowcharts illustrating an example of a search formula generation method. In FIGS. 18A and 18B, a variable u, a variable z, a constant U, and a constant Z are used. The variable z is used for counting the number of entries that have been set as processing targets among entries including the same classification category as a packet that includes a processing target IMSI. The constant Z is the total number of entries including the same classification category as the packet that includes the processing target IMSI. The variable u has an IP_TEID to be used as a search key and is used for counting the number of entries that have been set as processing targets among entries including the same classification category as the processing target IMSI. The constant U is the total number of entries that have an IP_TEID to be used as a search key and include the same classification category as the processing target IMSI. Note that FIGS. 18A and 188 are an example of the processing, and the processing may be modified according to the implementation. For example, the order of steps S91 and S92 may be arbitrarily changed.

When acquiring information of the processing target IMSI, the generation unit 91 extracts, from the mapping table 83, an entry including the same classification category as the processing target IMSI (step S91). The generation unit 91 sets the variable z to 1 (step S92). The generation unit 91 searches the mapping table 83 using an IP_TEID in a z-th entry as a key (step S93). The generation unit 91 determines whether a plurality of entries has been returned by the search for entries including the IP_TEID in the z-th entry (step S94). In a case where a plurality of entries has not been returned by the search for entries including the IP_TEID in the z-th entry, the IP_TEID that has been set as a processing target is not being used by a plurality of terminals 7 (No in step S94). Thus, a packet that includes the z-th IP_TEID may be set as a target of classification processing. Thus, the generation unit 91 generates a search formula for searching for a packet associated with the z-th IP_TEID and the processing target IMSI (step S95). Thereafter, the generation unit 91 increments the variable z by one, and then compares the variable z with the constant Z (steps S105 and S106). In a case where the variable z does not exceed the constant Z, there is an unprocessed entry, so the generation unit 91 repeats the processing from step 93 (No in step S106). On the other hand, in a case where the variable z exceeds the constant Z, the generation unit 91 determines that all the entries including the processing target IMSI have been processed, and ends the processing (Yes in step S106).

In a case where a plurality of entries has been returned in step S94, the z-th IP_TEID is being used by a plurality of terminals 7 (Yes in step S94). Thus, the generation unit 91 performs processing for including, in the search formula, a condition for specifying a period during which a terminal 7 to which the processing target IMSI is allocated is using the z-th IP_TEID. First, the generation unit 91 specifies a time Ts of an entry that includes the IP_TEID used as the key and a classification category that is the classification category of the processing target IMSI (step S96). Note that the time Ts is a time in the entry that includes the IP_TEID used as the key and the classification category that is the classification category of the processing target IMSI. Thus, the time Ts is the start time of use of the z-th IP_TEID by the terminal 7 to which the processing target IMSI is allocated.

The generation unit 91 sets the variable u to 1 (step S97). The generation unit 91 specifies a time (Tu) included in a u-th entry among the entries returned by the search processing in step S93 (step S98). The generation unit 91 determines whether the time Tu is later than the time Ts (Tu>Ts) (step S99). In a case where the time Tu is later than the time Ts, the time Tu is a time later than the end time of use of the z-th IP_TEID by the terminal 7 to which the processing target IMSI is allocated (Yes in step S99). Thus, the generation unit 91 sets the u-th entry as a candidate for an entry that may be used for a period setting (step S100). On the other hand, in a case where the time Tu is equal to or earlier than the time Ts, the time Tu is a time equal to or earlier than the start time of use of the z-th IP_TEID by the terminal 7 to which the processing target IMSI is allocated (Yes in step S99). Thus, in a case where the time Tu is equal to or earlier than the time Ts, the generation unit 91 does not set the u-th entry as a candidate for an entry that may be used for the period setting. After the processing in step S100, or in a case where the determination result in step S99 is “No”, the generation unit 91 increments the variable u by one, and compares the variable u with the constant U (steps S101 and S102). In a case where the variable u does not exceed the constant U, there is an entry that has not been set as a processing target among the entries returned in step S93, so the generation unit 91 repeats the processing from step S98. On the other hand, in a case where the variable u exceeds the constant U, the generation unit 91 has set, as processing targets, all the entries returned in step S93 (Yes in step S102). Thus, the generation unit 91 specifies a time T_{E} of an entry that is the earliest among candidates for an entry that may be used for the setting (step S103). The generation unit 91 generates a search formula for setting, as a packet related to the processing target IMSI, a packet that Includes the z-th IP_TEID and is associated with the obtained period Ts≤Time<T_{E} (step S104). The search formula generated in step S104 is, for example, the following formula. IMSI=processing target IMSI∥IP_TEID=z-th IP_TEID && Ts≤Time<T_{E} Thereafter, the generation unit 91 performs the processing from step S105.

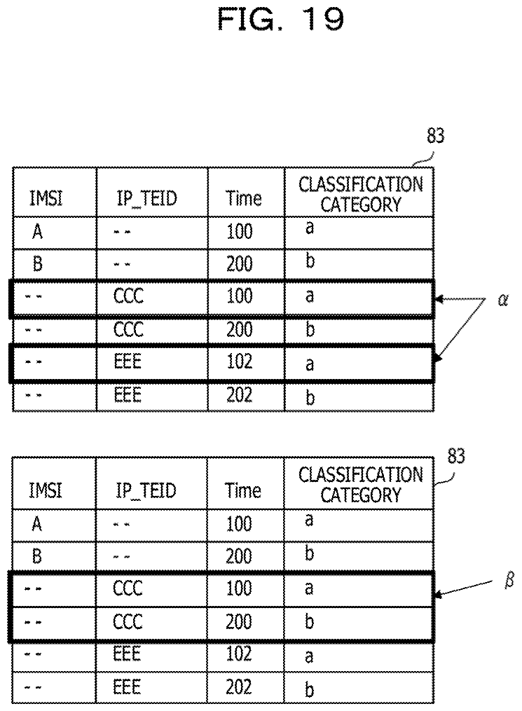

FIG. 19 is a diagram illustrating an example of the search formula generation method. An example of a case in which a search formula for a packet related to a terminal 7a identified by the IMSI A is generated will be described with reference to FIG. 19. For example, it is assumed that the mapping table 83 is as illustrated in FIG. 19. The generation unit 91 specifies that the processing target IMSI is associated with a classification category a. Next, the generation unit 91 searches the mapping table 83 using the classification category a as a key (step S91 in FIG. 18A). Then, as indicated by a in FIG. 19, an entry including an IP_TEID 00C and Time 100 and an entry including an IP_TEID EEE and Time 102 are returned.

First, it is assumed that the generation unit 91 performs processing for the IP_TEID CCC. In this case, since the generation unit 91 searches the mapping table 83 using the IP_TEID CCC as a key, an entry including the classification category a and Time 100 and an entry including a classification category b and Time 200 are obtained as indicated by P in FIG. 19. Thus, the generation unit 91 sets, as Ts in a search formula for the IP_TEID CCC, Time 100 that is the time in the entry that Includes the IP_TEID CCC used as the key and the classification category a (step S96 in FIG. 18A). The time in the entry that is not used for specifying the time Ts is Time 200, which is later than Ts in the search formula for the IP_TEID CCC. Thus, the generation unit 91 sets Time 200 as T_{E} in the search formula for the IP_TEID CCC (step S103 in FIG. 18A). Thus, 100≤Time<200 is set as a condition on the period in the search formula for the IP_TEID CCC.

The generation unit 91 performs processing also for the IP_TEID EEE in a similar manner. In other words, for example, the following entries are extracted by searching the mapping table 83 using the IP_TEID EEE as a key.

First entry returned

IP_TEID: EEE

Time: 102

classification category: a

Second entry returned

IP_TEID: EEE

Time: 202

Classification category: b

Thus, the generation unit 91 sets, as Ts in a search formula for the IP_TEID EEE, Time 102 that is the time in the entry that includes the classification category a (step S96 in FIG. 18A). Moreover, the generation unit 91 sets Time 202 as T_{E} in the search formula for the IP_TEID EEE (step S103 in FIG. 18A). Thus, 102≤Time<202 is set as a condition on the period in the search formula for the IP_TEID EEE.

By putting together these two conditions, the generation unit 91 generates a search formula for a packet related to the terminal 7a identified by the IMSI A as described below.

IMSI=A ∥

IP_TEID=CCC && (100:5 Time<200) ∥

IP_TEID=EEE && (102 Time<202)

The generation unit 91 outputs the generated search formula to the search unit 92.

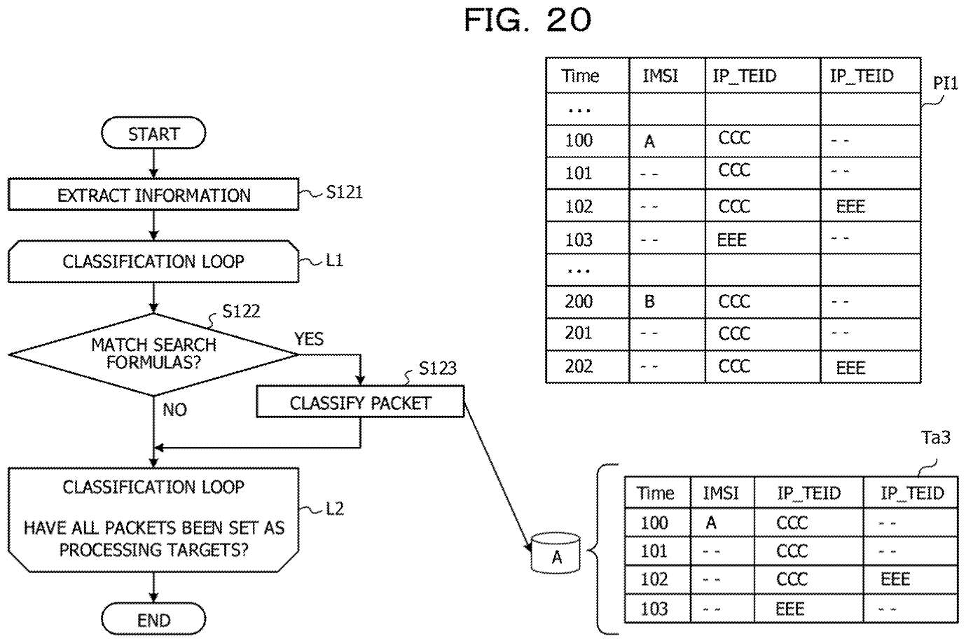

FIG. 20 is a diagram illustrating an example of packet search processing. In the example in FIG. 20, as in the first embodiment, it is assumed that a group of packets illustrated in P1 is input to the information processing apparatus 95. As in the first embodiment, information is extracted from the input group of packets (step S121). Thus, the map information 81, the map auxiliary Information 82, and the mapping table 83 are generated. Furthermore, it is assumed that the mapping table 83 is used to generate the search formula described with reference to FIG. 19.

Next, loop processing that lies between loop limits L1 and L2 is performed. The loop that lies between loop limits L1 and L2 may be hereinafter referred to as a “classification loop”. The search unit 92 determines whether a processing target packet matches the search formula (step S122). In a case where the processing target packet matches the search formula, the search unit 92 outputs the packet to the classification control unit 60 (Yes in step S122). In the classification control unit 60, the plurality of classification processing units 70 that includes a plurality of threads performs classification processing as in the first embodiment (step S123). On the other hand, in a case where the processing target packet does not match the search formula, the search unit 92 ends the processing for the processing target packet (No in step S122). In a case where the determination result in step S122 is “No”, or in a case where the processing in step S123 has been completed, the search unit 92 determines whether all packets have been set as processing targets (loop limit 12). In a case where not all the packets have been set as processing targets, the search unit 92 sets another unprocessed packet as a processing target and repeats the processing from step S122 (No in loop limit L2). On the other hand, in a case where all packets have been set as processing targets, the search unit 92 ends the processing (Yes in loop limit 12). Thus, as illustrated in Table Ta3, packets transmitted and received by the terminal 7a identified by the IMSI A are stored in the classification category a.

In the second embodiment, targets of classification processing may be limited to packets transmitted and received by a specific terminal 7. This further improves the efficiency of acquiring information to be used for analysis of a failure that has occurred in a network. Moreover, also in the second embodiment, information such as the mapping table 83 is stored in the storage unit 80. Thus, even in a case where packets are processed in parallel by a plurality of threads, each thread may specify a classification category of a processing target packet by using the Information in the storage unit 80. Thus, all processing target packets may be processed regardless of how the packets are allocated to each classification processing unit 70, and, at the same time, a time taken for packet classification processing may be shortened. Consequently, by using the information processing apparatus 95 according to the embodiment, information to be used for analysis of a failure that has occurred in a network may be obtained more quickly.

### Others

Note that embodiments are not limited to those described above, and various modifications may be made. Some examples are described below.

The above description has taken as an example the case where the protocol used for transmission and reception of packets is GTP. Even in a case where the protocol used is other than GTP, packet classification processing may be performed in a similar manner.

Note that information obtained by classification processing may be output to anywhere. For example, information obtained by classification processing may be output to an output device 104 included in an information processing apparatus 10 or an information processing apparatus 95 as appropriate. Furthermore, information obtained by classification processing may be transmitted from the information processing apparatus 10 or the information processing apparatus 95 to a device operated by an operator or the like via a communication unit 15 as appropriate.

In the second embodiment, there may be a case where the time T_{E} is not obtained. For example, there may be a case where the mapping table 83 does not include an entry including a time equal to or later than the time Ts for the IP_TEID classified into the same classification category as the processing target IMSI. In this case, since it means that no terminal 7 using the IP_TEID has been confirmed since the IP_TEID was used by the terminal 7 corresponding to the processing target IMSI, time Ts 5 Time is included in the search formula as a condition on the period.

The packets and tables described in the above description are examples, and the information elements included in the packets and tables may be changed according to the implementation.

Moreover, the number of threads for extracting information used for classification from packets and the number of threads for performing packet classification processing are both arbitrarily. Furthermore, the number of threads for extracting information used for classification from packets and the number of threads for performing packet classification processing may be the same, or may be different.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a packet classification program for causing an information processing apparatus to perform processing comprising:
storing, by every one of a plurality of threads, in a case where input packets include identification information of terminals, in a memory, identification information of sessions used for transmitting the input packets, in association with classification categories associated with the terminals and time information in the input packets;
specifying, by every one of a plurality of classification threads that performs classification processing of the input packets, in a case where a target packet of the classification processing does not include identification information of a terminal that processes the target packet, classification categories associated with identification information of a session used for transmitting the target packet and a time equal to or earlier than time information in the target packet, by referencing the memory; and
classifying the target packet into a classification category associated with a relatively later time among the specified classification categories.

2. The non-transitory computer-readable recording medium according to claim 1, wherein
the packet classification program configures settings for causing every one of the plurality of threads to
store, in a case where the input packets do not include the identification information of the terminals that process the input packets but include identification information of a first session and identification information of a second session, the input packets in the memory in association with the identification information of the first and second sessions, and
classify, in a case where the identification Information of the first session is not associated with a plurality of the classification categories, the packets that include the identification information of the second session into a classification category associated with the identification information of the first session.

3. The non-transitory computer-readable recording medium according to claim 2, wherein
the packet classification program configures settings for causing every one of the plurality of threads to
specify, in a case where the identification information of the first session is stored in the memory in association with a first entry that includes a first classification category and first time information included in a packet used to specify the first classification category and a second entry that includes a second classification category and second time information included in a packet used to specify the second classification category, a third time included in the input packets,
choose the first time or the second time, whichever is equal to or earlier than the third time and is relatively later, and
classify a packet that includes the identification Information of the second session into a classification category included in the same entry as the chosen time.

4. The non-transitory computer-readable recording medium according to claim 1, wherein
the packet classification program causes the information processing apparatus to further perform processing comprising:
generating, on the basis of input information, a search formula expressing a condition for searching a packet to be set as a target of the classification processing by the plurality of classification threads; and
inputting a packet that satisfies the search formula to one of the plurality of classification threads.

5. A packet classification method for causing an information processing apparatus to perform processing comprising:
using every one of a plurality of threads to store, in a case where input packets include identification information of terminals, in a memory, identification information of sessions used for transmitting the input packets, in association with classification categories associated with the terminals and time information in the input packets; and
using every one of a plurality of classification threads that performs classification processing of the input packets to
specify, in a case where a target packet of the classification processing does not include identification information of a terminal that processes the target packet, classification categories associated with identification information of a session used for transmitting the target packet and a time equal to or earlier than time information in the target packet, by referencing the memory, and
classify the target packet into a classification category associated with a relatively later time among the specified classification categories.

6. An information processing apparatus comprising:
a memory; and
a processor coupled to the memory and configured to:
store, in a case where input packets include identification information of terminals, in the memory, identification information of sessions used for transmitting the input packets, in association with classification categories associated with the terminals and time information in the input packets;
determine, in a case where a target packet of classification processing does not include identification information of a terminal that processes the target packet, a classification category associated with a relatively later time among classification categories associated with identification Information of a session used for transmitting the target packet and a time equal to or earlier than time information in the target packet, by referencing the memory; and
classify the target packet in association with the determined classification category.
